(19) United States
(12) Patent Application Publication
(10) Pub. No.: US 2003/0218947 A1
(43) Pub. Date: Nov. 27, 2003

(54) Transducer for converting digital AV content to optical compatible signals and associated operating method

(75) Inventors: Willam S. Herz, Hayward, CA (US); Daniel R. Salmonsen, Saratoga, CA (US)

Correspondence Address: KOESTNER BERTANI LLP, 18662 MACARTHUR BLVD, SUITE 400, IRVINE, CA, 92612, US

(73) Assignee: Oak Technology, Inc., Sunnyvale, CA

(21) Appl. No.: 10/154,172

(22) Filed: May 21, 2002

(51) Int. Cl. G11B 7/095; G11B 7/135

(52) U.S. Cl. 369/44.37; 369/112.27; 369/121

(57) ABSTRACT

An optical appliance that is capable of processing optical media can be used to modulate a laser. In some systems, the optical appliance includes an opto-electronic transducer, a compact disk (CD) or digital versatile disk (DVD) controller and front end. A a modulated laser can be used as an optical network with a terminal node in the form of a conventional optical detector such as a compact disk (CD) or digital versatile disk (DVD) pickup. A CD or DVD controller and front end can be used to modulate the laser. Accordingly, the controller and front end can modulate the laser to emulate reading of an optical disk medium.

### BACKGROUND OF THE INVENTION

1. Field of the Invention

The invention relates generally to systems that include optical storage devices or optical storage and recording devices.

2. Relevant Background

A deployed base of legacy consumer electronic appliances exists that may be obsolete or cannot be upgraded in functionality but, by virtue of cost and embedded physical nature, these appliances are not readily replaced. Examples of such embedded appliances include automotive tape decks, automotive compact disk players, automotive DVD players, and personal entertainment centers, to name a few.

New technologies and consumer products are constantly evolving. Although attempts are sometimes made to conform standard aspects of new devices to old technology, a problem arises when an incumbent, embedded appliance cannot be merged with the new technology. Specifically, automotive CD player decks and jukeboxes do not play CD-R, CD-ROMs, or non-CD formatted content. A consumer has no alternative other than to install a new player.

A similar problem arose in the field of audio cassette decks. The problem was addressed by converting the analog stereo signal to a magnetic rendering, allowing a cassette deck's pick up head to interpret the information as if a tape was inserted.

For CD and DVD players, no equivalent conversion exists to allow new content and formats to be processed by the physically embedded appliance.

### SUMMARY OF THE INVENTION

In accordance with one aspect of an appliance that is capable of processing optical media and thus includes an opto-electronic transducer, a compact disk (CD) or digital versatile disk (DVD) controller and front end can be used to modulate a laser.

In another aspect, a modulated laser can be used as an optical network with a terminal node in the form of a conventional optical detector such as a compact disk (CD) or digital versatile disk (DVD) pickup. A CD or DVD controller and front end can be used to modulate the laser. Accordingly, the controller and front end can modulate the laser to emulate reading of an optical disk medium.

In a further aspect, an opto-electronic transducer inserts a laser emitter into a conventional opto-electronic device so that the device processes a laser signal from the emitter as if read from an optical media.

Another aspect of an opto-electronic system is a capability to maintain a laser emitter in an essentially fixed location while mounted on a rotating platter.

Still another aspect is a control apparatus with a capability to override control operations of a conventional opto-electronic device. In one example, the control operations overridden can be selected from among error correcting, servo control, and track locking correction. In a particular system, the control apparatus can be implemented though firmware modifications using existing opto-electronic controller and front end circuitry. Suitable controller and front-end circuitry can be a CD-R/W controller and CD-R/W front-end circuitry. Other suitable examples include any other optical controllers and interface circuitry such as DVD controllers and front-end circuitry.

In accordance with an aspect of the described system, an opto-electronic apparatus includes an opto-electronic transducer and a substrate. The opto-electronic transducer is capable of converting the electronic signal to an optical signal. The substrate is capable of coupling to the opto-electronic transducer and has a form factor of an optical record medium. The substrate is capable of substituting for the optical record medium and delivering the optical signal to an optical pickup of an opto-electronic device.

In accordance with another aspect, an opto-electronic apparatus comprises a laser emitter and an opto-electronic transducer. The opto-electronic transducer includes an input terminal capable of receiving electronic signals. The transducer is capable of controlling a CD or DVD controller and front end to modulate a laser, thereby converting the electronic signals to optical signals that emulate the operation of reading optical media by a conventional opto-electronic device.

In accordance with another aspect, a method of operating an opto-electronic apparatus comprises sensing an electronic signal, and modulating a laser using a conventional CD or DVD player to receive the electronic signal, converting the electronic signal to an optical signal. The optical signal emulates signals generated by reading of optical media using a conventional opto-electronic device.

In accordance with a further aspect, an opto-electronic apparatus comprises a laser illumination source, a laser driver coupled to the laser illumination source and capable of driving the laser illumination source, and an opto-electronic controller. The opto-electronic controller is coupled to the laser driver and the laser illumination source to modulate the laser illumination source. The modulated laser illumination is capable of usage as an optical network having a terminal node that is the optical pickup of an opto-electronic device. The opto-electronic device can be a conventional CD or DVD player.

In accordance with another aspect, a method of operating an opto-electronic apparatus comprises modulating a laser illumination source and using the modulated laser illumination as an optical network having a terminal node that is the optical pickup of an opto-electronic device. The opto-electronic device can be a conventional CD or DVD player.

In accordance with still another aspect, the opto-electronic apparatus comprises a laser emitter and a substrate including a support for holding the laser emitter. The substrate is capable of inserting the laser emitter into the opto-electronic device so that the opto-electronic device processes illumination from the laser emitter in the manner that the opto-electronic device reads from an optical medium.

With respect to still another aspect, a method of operating an opto-electronic apparatus comprises supporting a laser emitter on a substrate and inserting the substrate and laser emitter into the opto-electronic device. The opto-electronic device processes illumination from the laser emitter in the manner that the opto-electronic device reads from an optical medium.

According to a further aspect, opto-electronic apparatus comprises a laser emitter and a substrate mountable on a rotatable turntable of a conventional opto-electronic device. The substrate is capable of holding the laser emitter and maintaining the laser emitter in a substantially fixed position as the turntable rotates.

With regard to another aspect, a method of operating an opto-electronic apparatus comprises mounting a substrate on a rotatable turntable of a conventional opto-electronic device and holding a laser emitter in a substantially fixed position while rotating the turntable, not requiring any modification to the player.

According to a further aspect, opto-electronic apparatus comprises a laser illumination source, a laser driver coupled to the laser illumination source and capable of driving the laser illumination source, and an opto-electronic controller. The opto-electronic controller is coupled to the laser driver and the laser illumination source to modulate the laser illumination source. The modulated laser illumination is capable of usage as an optical network having a terminal node that is the optical pickup of an opto-electronic device. The opto-electronic device can be a conventional CD or DVD player. The opto-electronic controller is capable of driving the laser illumination source to perform one or more control operations that are capable of overriding control operations of the conventional CD or DVD player. The control operations of the conventional CD or DVD player being selected from among an error correcting operation, a servo control operation, and a track locking correcting operation.

With respect to still another aspect, method of operating an opto-electronic apparatus comprises modulating a laser illumination source, using the modulated laser as an optical network having a terminal node that is the optical pickup of an opto-electronic device, and driving the laser illumination source to perform one or more control operations. The control operations are capable of overriding control operations of the opto-electronic device.

### BRIEF DESCRIPTION OF THE DRAWINGS

The features of the described embodiments believed to be novel are specifically set forth in the appended claims. However, embodiments of the invention relating to both structure and method of operation, may best be understood by referring to the following description and accompanying drawings.

FIG. 1 is a schematic block diagram showing an example of an opto-electronic transducer in an illustrative opto-electronic apparatus.

FIG. 2 is a schematic block diagram showing an example of a mechanical element in an opto-electronic apparatus.

FIG. 3 is a simplified block diagram that illustrates an embodiment of an optical disk drive system.

FIG. 4 is a schematic block diagram that depicts an example of a suitable optical pickup unit that may be used in an optical device such as the optical disk drive system.

FIG. 5 is a schematic pictorial diagram that shows a suitable diode arrangement for focus search and tracking operations.

FIG. 6 is a generic drawing showing an example of a portion of a possible pattern on an optical medium and the light pattern detected by the photodiode arrangement in an optical pickup unit.

FIGS. 7A, 7B, and 7C are schematic pictorial diagrams that respectively show illumination patterns under some conditions.

FIGS. 8A, 8B, and 8C are schematic circuit diagrams depicting examples of suitable circuits for analyzing a focus path, a radio frequency (RF) path, and RF crossing, respectively.

### DESCRIPTION OF THE EMBODIMENT(S)

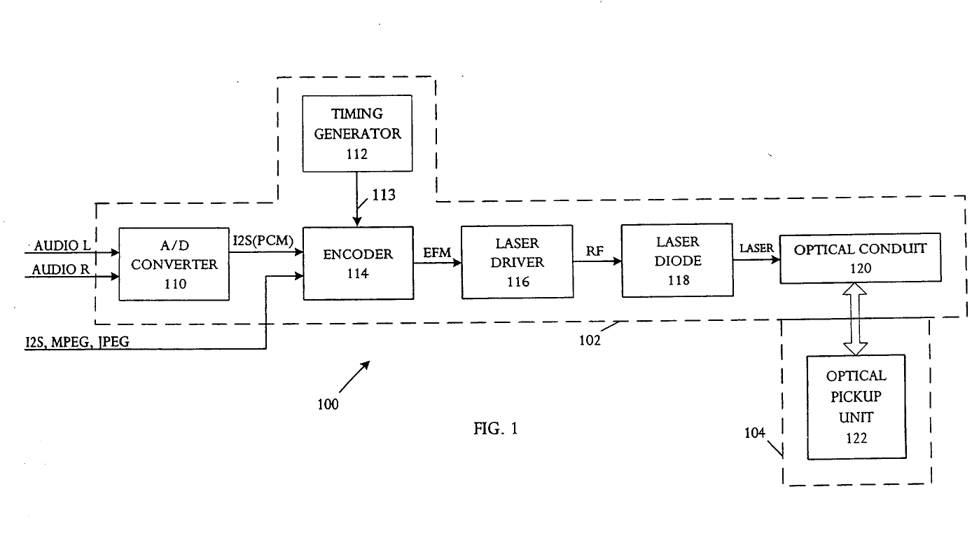

Referring to FIG. 1, an opto-electronic apparatus, here a digital AV to optical conversion apparatus 100, includes an electrical element 102 and a mechanical element 104. The electrical element 102 may be termed an opto-electronic transducer and performs electrical transduction of an analog or digital signal into an optical format, such as a laser format, that is compatible with an optical pickup unit and signal processing of an embedded opto-electronic appliance. The mechanical element 104 may be termed a substrate and emulates functionality of an optical medium in an otherwise closed system. The mechanical element 104 permits substitution of transduced information from the electrical element 102 for data from the closed-system optical medium.

The electrical element 102 includes a plurality of functional blocks that operate in combination to convert analog signals to an optical format compatible with the optical pickup device. The electrical element 102 of the digital AV to optical conversion apparatus 100 includes an analog-to-digital converter 110, an optical drive encoder such as a CD/DVD encoder 114, a laser driver 116 that is capable of controlling signal power levels, and a laser diode 118 capable of applying illumination or optical signals to an optical conduit 120. Various other functional elements are not shown but also may be inserted into the electrical element 102 that forms an audio-to-optical signal pathway in some applications. Typical pathway elements may include signal decoders, signal detectors, timing signal generators, filters including low-pass, high-pass, or bandpass filtering.

The electrical element 102 has input terminals capable of receiving electronic signals in the form of analog signals and digital signals. The analog signals can be supplied from a variety of input devices. A device as simple as a headphone jack of an MP-3 player may supply the analog signals. Various systems may receive input signals in the form of any type of audio or video signals including optical signals, analog video, MPEG signals, wireless signals (IEEE 802.11 standard), or other suitable signals. Digital signals of any type can also be supplied, such as but not limited to various standards of MPEG, JPEG, or digital signals compliant with the Inter-IC Sound (I2S) standard from the digital output terminal of a digital versatile disk (DVD) player. The I2S protocol is known to those having ordinary skill in the audio system art for transmitting two channels of digital audio data over a single serial connection. In other applications, the digital signals may be compressed MPEG (Motion Pictures Experts Group, any MPEG standard) or JPEG (Joint Photographic Experts Group). The compressed MPEG or JPEG data may be acquired from a video imaging device such as a camcorder or the like.

Audio signals Audio L and Audio R are digitized into a digital format such as a pulse code modulation (PCM) signal or I2S using an analog-to-digital converter (ADC) 110. In some examples, audio signals may be pre-amplified prior to application to ADC 110 using a pre-amplifier (not shown). In addition to analog signals, the digital AV to optical conversion apparatus 100 can also receive digital source content. In one typical example, the digital signals can be supplied from a SPDIF connector of a DVD player. The digitized audio signal is subsequently fed into a CD/DVD encoder 114 or other suitable device for encoding a signal. One example of a device suitable for usage as the CD/DVD encoder 114 is an OTI-9897 Highly Integrated CD-RW/DVD-ROM controller, manufactured by Oak Technology, Sunnyvale, Calif. Other devices are also suitable for usage as the encoder.

Digital format information data is applied to a compact disk (CD), digital versatile disk (DVD) encoder 114 that encodes the digital data as a sequence of timed pulses for driving a laser diode 118 or other suitable illumination source or laser illumination source. The digital data can be passed to write circuitry (not shown) of the CD/DVD encoder 114. The encoder write circuitry includes a digital content interface, such as an ATAPI, I2S, or USB interface, and a write encoder for compact disk or digital versatile disk formats.

A clock signal 113 is applied to the CD/DVD encoder 114 for setting the timing and duration of signals applied to a laser driver 116 that activates the laser diode 118. A typical CD/DVD encoder 114 may perform operations including error checking and correction (ECC), modulation, and scrambling in accordance with the clock signal, for example to produce a modulated signal which is applied to the laser driver 116. In one particular example, a CD/DVD encoder 114 may convert an audio signal to a binary signal by adding an error correction code and performing EFM+signal, such as an 8-16 modulation signal, then supplying the processed digital signal to the laser driver 116.

A timing signal generator 112 typically is used to generate a synchronization signal that is applied to the CD/DVD encoder 114 and sets a standard for record timing in the CD/DVD encoder 114.

A digital information signal from the CD/DVD encoder 114 is applied to a laser driver 116 that applies a laser driving signal corresponding to the digital information signal. The laser driver 116 generally controls the power applied to the laser diode 118. In some embodiments, the laser driver 116 may include one or more filters to improve the shape of the digital signals. For example, the laser driver 116 may perform a power controlling operation that converts the digital waveform on a modulation signal from the encoder from the CD/DVD encoder 114 based on the record clock signal applied to the laser driver 116. The laser driver 116 generates an output signal in the form of a record signal that is capable of driving the laser diode 118. The laser driver 116 drives the laser diode 118 with a radio frequency signal that modulates the laser diode 118.

Although the illustrative embodiment depicts a signal path that includes the CD/DVD encoder 114, the laser driver 116, and the laser diode 118, the particular transducer elements may take a myriad of forms, using various circuits and devices. Functionally, the signal path includes an opto-electronic controller, a driver, and an illumination emitter that produces modulated illumination that is capable of usage as an optical network having a terminal node that is the optical pickup of an opto-electronic device. One suitable digital AV to optical conversion apparatus 100 utilizes an OTI-9797 CD-RW controller for the laser driver 116 and an OTI-9879 front end circuit for the laser diode 118, both of which are designed and manufactured by Oak Technology, Inc. of Sunnyvale, Calif.

Based on the record signal, the laser driver 116 generate a laser drive signal to drive the laser diode 118, causing the laser diode to generate an irradiating light beam, a laser beam.

In various embodiments, a system may include a system controller (not shown) that operates to set a laser power control value that is applied to the laser driver 116. Based on the laser power value, the laser driver 116 may include an automatic power control circuit or system that controls the amplitude of laser beams produced by the laser diode 118.

Although in a conventional optical system, a laser beam is focused on an optical medium, in the illustrative digital AV to optical conversion apparatus 100, the modulated laser is focused through an optical conduit 120 and delivered to an optical pickup unit (OPU) of an embedded optical system. For example, the modulated laser illumination from the laser diode 118 is emitted or focused onto a communication link or optical conduit 120, such as an optical fiber, and transmitted to an optical pickup unit (OPU) 122 of a standard optical or opto-electronic device. Examples of standard optical or opto-electronic devices include compact disk (CD) players, CD player decks, CD jukeboxes, digital versatile disc (DVD) players, CD or DVD player/recorders, and the like. The digital AV to optical conversion apparatus 100 can be particularly suitable for updating functional capabilities of legacy opto-electronic players or player-recorders or devices constrained within a closed system.

The opto-electronic controller controls the laser emission to generate illuminations that emulate signals that the optical pickup unit 122 receives as if reading from optical media. For example, the opto-electronic controller generates signals that emulate information recorded on the optical disk that typically includes data encoding and control encoding, called pre-information. Various types of pre-information include synchronization signals, address information for data searching, rotation control information, clock information.

The optical record medium has a surface extending in a plane generally with alternating elevated and depressed tracks, called land tracks and groove tracks respectively. The land and groove tracks are formed into oscillations or waves that oscillate at a frequency that corresponds to the rotation speed of the disk. The optical record medium also has depressions, called pits, for storing information. The optical medium stores information in the pits and grooves. Typically, oscillations in the groove tracks are formed early in the manufacturing process of a disk. A pre-recorded optical record medium encodes record information, as distinguished from pre-information, that is recorded using a information recording apparatus that is well-known in the art of optical information storage systems.

The optical record medium stores information in the form of tracks and pits that are arranged into information units such as, for example, synchronization frames which can be further arranged into recording frames and information blocks. One type of information block is an error correcting code (ECC) block.

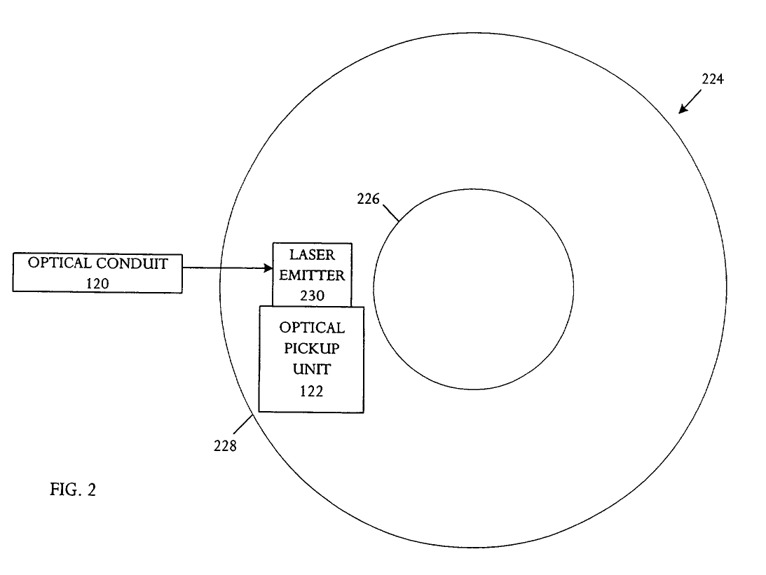

Referring to FIG. 2, the optical conduit 120 connects to the mechanical element 104. The mechanical element 104 includes a multiple-element disc 224. In the illustrative digital AV to optical conversion apparatus 100, the multiple-element disc 224 has standard CD/DVD form factor and size. In one example, the multiple-element disc 224 has two sections, a center section 226 that is free to rotate, and an outer section 228 that can be either fixed or moveable. A laser emitter 230 is mounted on the outer section 228. As a radially-moveable platter (not shown) of the embedded system rotates the center section 226 of the multiple-element disc 224, the laser emitter 230 remains stationary over the optical pickup unit 122. The optical pickup unit 122 processes a laser emission from the digital AV to optical conversion apparatus 100 in the same manner as a valid focused and tracked reflection from a conventional disk.

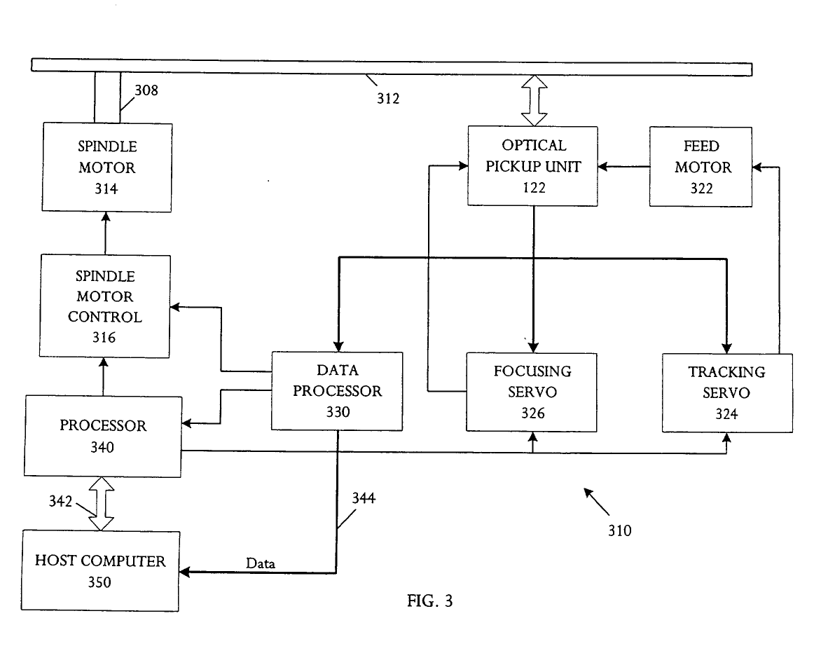

Referring to FIG. 3, a simplified block diagram of an optical device such as an optical disk drive system 310. Optical disk drive systems 310 operate by storing and retrieving information on an optical storage medium 312 at various track locations within the media. The system 310 typically employs a track search operation that quickly locates a track for storing or retrieving desired information. A typical search operation includes a process for counting the number of track crossings up to a targeted track, thereby precisely controlling the distance traveled and the velocity of the head. In the illustrative optical disk drive system 310, an optical disk 312 such as a CD-ROM or DVD is driven by spindle motor 314 under control of spindle motor controller 316. The spindle motor controller 316 may be an electronic circuit, a processor, a controller, microcontroller, state machine, a control logic such as a programmable control logic, or the like.

During typical operation of the optical disk drive system 310, the optical storage medium 312 is placed on a rotation device 308 such as a turntable and is rotationally driven at a constant linear velocity or a constant angular velocity by a spindle motor 314. The optical pickup unit 122 reads data recorded on the optical storage medium 312 in the form of grooves, pits or phase-change pits. A typical spindle motor 314 includes a spindle frequency generator (not shown) that is capable of executing a servo control operation. The spindle motor 314 can generate a frequency generator pulse in synchrony with rotation of the spindle motor 314. Information regarding the rotation of the spindle motor 314 can be determined based on timing of the spindle frequency generator pulses.

For example, a phase comparator (not shown) may be used to compare the phase of a time division signal with a standard clock reference signal including a standard frequency component of a rotation speed of the optical storage medium 312 as controlled by a standard clock generator (not shown). The phase comparator can send a difference signal as a rotation control signal through the spindle motor controller 316 to the spindle motor 314. In this manner, the spindle motor 314 operates under spindle servo control so that the optical storage medium 312 rotates at a speed based on frequency and phase of a standard clock signal.

In a particular example, the data processor 330 uses a spindle error signal SPE to generate a spindle drive signal that is applied to the spindle motor controller 316. Based on the spindle drive signal, the spindle motor controller 316 applies a control signal such as, for example, a three-phase signal to the spindle motor 314 to rotate the spindle motor 314 at constant linear velocity. The data processor 330 can also generate a more complex spindle drive signal such as a spindle kick/brake control signal from the processor 340 or the host computer 350 for finer control of the spindle motor 314. In one example, the spindle motor 314 can be started, stopped, accelerated, or decelerated by the spindle motor controller 316.

The processor 340 can also rotate the spindle motor 314 at various linear velocities. In one example, the spindle motor 314 can be controlled in combination with focusing and tracking control so that a reproduction clock signal is generated in synchrony with an EFM signal. Information concerning the current rotational velocity can be obtained from the reproduction clock signal. The data processor 330 or processor 340 can generate a spindle error signal SPE for performing a servo operation at constant linear velocity by comparing the current-rotational-velocity information and the standard-rotational-velocity information. By changing the standard-velocity information value, the processor 340 can change the constant linear speed, for example attaining a high data transfer rate. A system that utilizes a constant angular velocity spindle motor 314 permits control of rotational velocity.

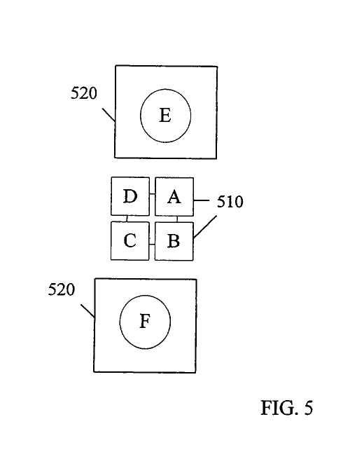

The optical pickup unit 122 retrieves or records information to and from optical disk 312 by means of photodiodes 510 and 520 shown in FIG. 5 properly placed above and below a desired track of the optical disk 312. The location of the optical pickup unit 122 is precisely positioned by a feed motor 322. The optical pickup unit 122 also generates a tracking error signal (TE) to maintain proper radial tracking in the optical disk drive system 310.

The optical disk drive system 310 further includes a processor 340, such as a microprocessor, a microcontroller, a control state machine, or the like, that communicates with a host computer 350, such as a central processing unit. Typically the processor 340 executes various operations based on commands from the host computer 350. The processor 340 controls various operations including encoding and decoding, and controls the spindle motor 314, a focusing servo 326 which in turn controls the optical pickup unit 122, and a tracking servo 324 which in turn controls the feed motor 322. Output signals from the optical pickup unit 122 are fed to focusing servo 326 and tracking servo 324 to facilitate operations. The optical pickup unit 122 output signals are also communicated to a data processor 330 to extract data which is fed via a bus 344 to host computer 350. The data processor 330 also generates signals for use by processor 340 and spindle motor controller 316 for various operations.

The optical disk drive system 310 generally performs various operations that control operations of the optical pickup unit 122 and the spindle motor 314. For example, a controller in the optical disk drive system 310, typically the processor 340, performs operations such as servo control, error correction, and track lock to access data on the optical storage medium 312. In an illustrative optical disk drive system 310, firmware that is executable by the processor 340 may be modified to characterize an alternative emulation of the control operations.

A conventional CD or DVD reading device performs a focus search and tracking lock prior to searching for the lead-in region in the innermost readable area of the disc to determine the disc type. Determination of the disc type precedes an attempt to read any data.

Referring to FIG. 5 in combination with FIG. 1, a conventional CD or DVD reading device typically performs a focus search operation by directing light from a read laser to the disc surface and moving a lens up and down with respect to the media surface in an attempt to find a focal point. FIG. 5 shows a suitable diode arrangement for focus search and tracking operations, including an array 510 of photosensitive diodes A, B, C, and D for focus search, and photo diodes 520 (E and F) for a tracking loop. In one example, the focal point is defined as the location where the reflected light from an external source is equally distributed among an astigmatic focus array of multiple photosensitive diodes. The array includes four photosensitive diodes 240 arranged in a square pattern to allow feedback of illumination information.

A beam of directed light from a read laser that illuminates the E and F photo diodes 520 is modulated by track crossings and EFM (eight to fourteen modulation) data. EFM transitions are much higher in frequency and more filtered than the track crossings. Light to dark transitions of filtered data from the E and F photo diodes 520 are used to count track crossings. Track crossings can also be detected using light to dark transitions of the array 510 of photosensitive diodes A, B, C, and D. The direction of track crossings can be determined by the phase relationship of the E and F photo diodes 520 as compared to transitions of the array 510 of photosensitive diodes A, B, C, and D.

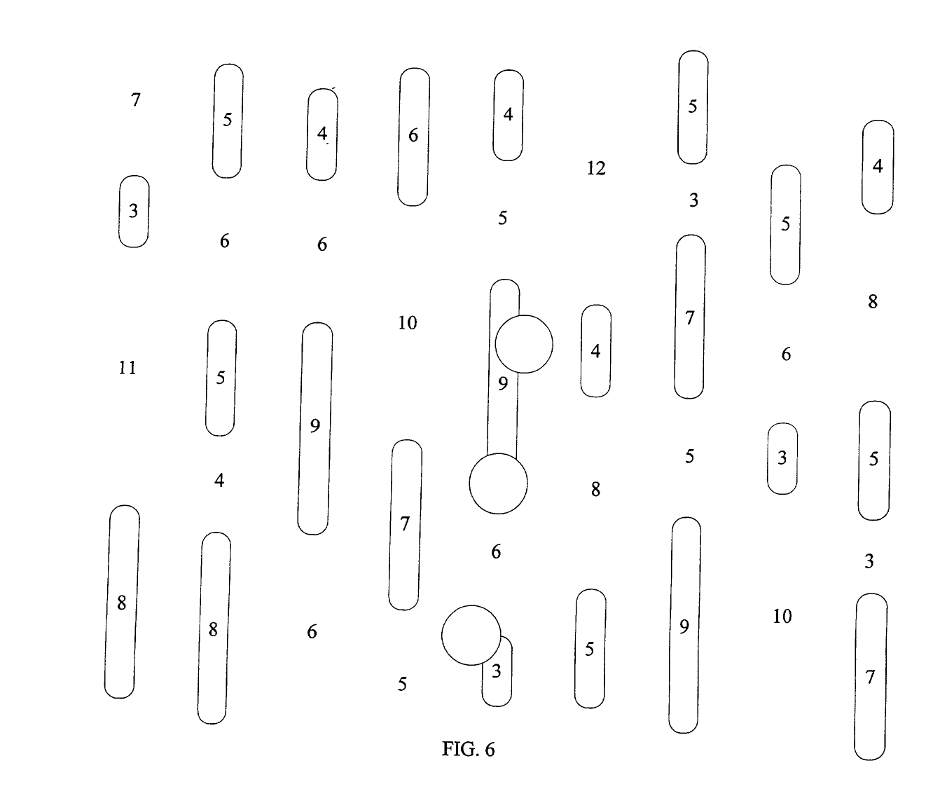

Referring to FIG. 6, a generic drawing shows an example of a portion of a possible pattern on an optical medium and the light pattern detected by the photodiode arrangement in an optical pickup unit.

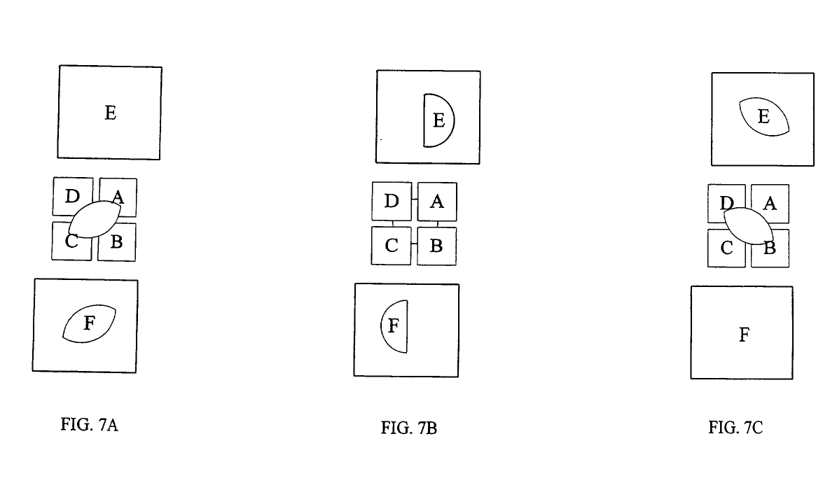

Referring to FIGS. 7A, 7B, and 7C, schematic pictorial diagrams respectively show illumination patterns detected when a lens is: too close and left of track, in focus on track, and too far and right of track.

In the digital AV to optical conversion apparatus 100, the focus search operation is overridden by directing light from an external source, for example the laser diode 118, into the optical pickup unit 122 in a manner that illuminates all regions of the photodiode array equally. When all regions are illuminated equally, the focus servo control loop of the conventional optical device will determine that focus lock is attained since the relative input error among the photodiodes is essentially equal to zero due to equality of light strength received at each photo diode.

The digital AV to optical conversion apparatus 100 utilizes a similar control technique to override a tracking loop operation. In one example of a conventional tracking loop operation, two photodiodes 250 are used to supply tracking feedback based on the difference between light intensity received at each photodiode. The digital AV to optical conversion apparatus 100 overrides the conventional tracking loop operation by directing light from an external source, for example the laser diode 118, into the optical pickup unit 122 in a manner that illuminates both of the diodes equally. Accordingly, the tracking servo control loop determines that tracking lock is attained since the input error between the photodiode signals is very small or essentially equal to zero due to equality of illumination strength received at each photo diode.

The input signal to the focus servo control loop is typically never equal to zero. Therefore, the external illumination source of the digital AV to optical conversion apparatus 100 is operated to create non-equal light intensities of the correct polarity to maintain focus and tracking movements within a predefined range. External illumination is controlled to drive the focus servo appropriately to consistently reduce the error signals and satisfy the servo control loop. Accordingly, the focus and tracking movements are prevented from drifting to extreme ranges or from moving outside of the range of the light source.

The digital AV to optical conversion apparatus 100 modulates the external light source according to CD and DVD standards to create a radio frequency (RF) output signal from the focus search photodiodes. Once the focus search and tracking loops have locked onto the external light source, the light source modulations are received and recognized by the reading system as valid lead-in data.

In an illustrative optical disk drive system 310, via a communication link 342 the host computer 350 may issue a read command to the processor 340 that requests transfer of specific data recorded on the optical storage medium 312, generating a seek operation with a specified address as a target. A seek refers to the operation of moving an optical head or objective lens roughly to the vicinity of a target address. In contrast, a data access is an operation that includes the seek operation but further encompasses precise movement of the objective lens to a desired location, and reading of the data. The processor 340 responds to the read command by generating a command to the focusing servo 326 to cause the optical pickup unit 122 to access the target address specified by the seek command. The optical pickup unit 122 accesses the data and passes the specified data and control information to the data processor 330, the focusing servo 326, and the tracking servo 324 so that the accessed data is decoded and stored.

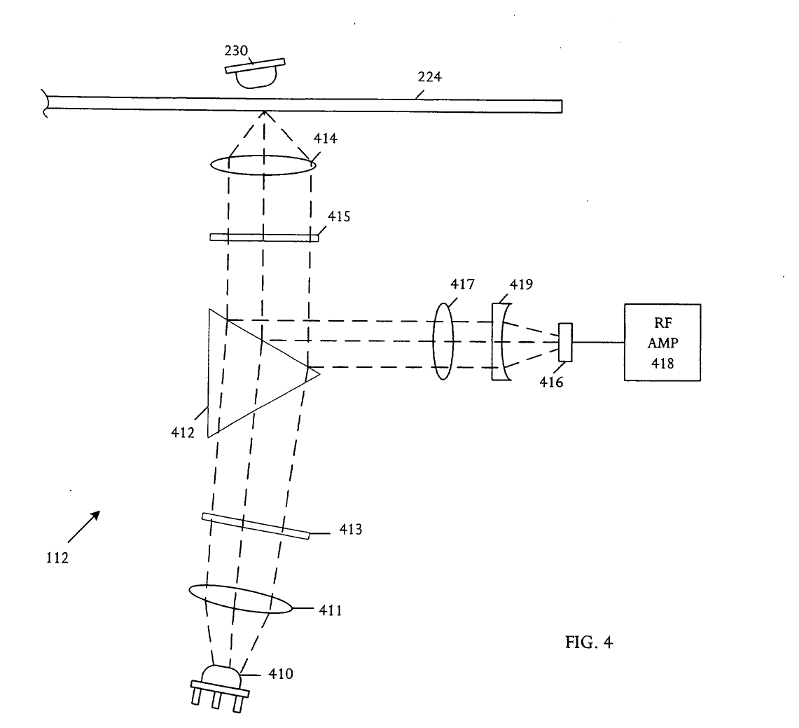

Referring to FIG. 4, a schematic block diagram depicts an example of a suitable optical pickup unit 122 that may be used in an optical device such as the optical disk drive system 310. The optical pickup unit 122 may be interfaced to the digital AV to optical conversion apparatus 100. In the illustrative example, the optical disk drive system 310 has an optical pickup unit 122 that contains an OPU laser 410 that is capable of generating a light beam to illuminate an optical medium or, in the illustrative configuration, the multiple-element disc 224. The light beam produced by the OPU laser 410 passes through a collimator lens 411 and an optical grating 413 to a polarization beam splitter 412. The optical grating 413 divides incident light into a primary beam for reading information from the optical medium and one or more secondary beams for control operations.

The beam splitter 412 has a partial reflection film (not shown) which transmits a portion of the light from the OPU laser 410 to the optical medium, but reflects a remaining part of the beam. For a beam splitter 412 with a film having a typical reflectance, most of the light beam is transmitted through the beam splitter 412 to a quarter wavelength plate 415 and collected by an objective lens 414 on an information record surface of the optical medium. The transmitted light forms a beam spot having a predetermined size on the optical medium.

In conventional operation, the light beam collected on the information record surface of the optical medium is reflected back to the beam splitter 412 through the objective lens 414 and the quarter wavelength plate 415. The reflection film of the beam splitter 412 is configured to reflect substantially all of the light passing in the direction from optical medium through a collection lens 417 and a cylindrical lens 419 to a light detector 416. In the illustrative system, the digital AV to optical conversion apparatus 100 can be controlled to generate laser emissions that emulate, simulate, or mimic reflections from a conventional disk.

The optical pickup unit 122 may possibly include other functional elements that are known in the art of optical player and/or recorder devices, none of which are shown in the illustration. One example of an additional functional element is a radio frequency (RF) amplifier 418. In various embodiments, an electrical signal processing element such as the RF amplifier 418 may be included within or be external to the optical pickup unit 122.

During reading of information from the optical storage medium 312, the processor 340 operates to set a laser illumination value and transfer the value to a laser driver (not shown). Based on the laser power setting, the laser driver drives illumination of the OPU laser 410 to generate laser beams.

The optical pickup unit 122 can irradiate signal-record surfaces with laser beams through the objective lens 414, and can guide reflected light beams to the photodetector 416. The objective lens 414 is held by a movement device (not shown) such as a biaxial motion mechanism to permit movement in a tracking direction and a focusing direction. The entire optical pickup unit 122 can be moved in a disk radial direction by a movement device such as a feed motor 322 that is capable of moving a translational frame (not shown) such as a sled mechanism.

The optical pickup unit 122 generates the illumination beam, detects optical signals reflected from the surface of the optical media when illuminated, and for an optical device 300 that is a recorder as well as a player, transmits recording signals onto the media surface for storage. The optical pickup unit 122 generates an illumination beam onto an information or data recording surface of an optical media such as a CD or DVD disc. Information carried by these laser illumination beams reflected from the optical storage medium 312 is detected by the photodetector 416. The photodetector 416 generates electrical current that varies according to the amount of received illumination and supplies the electrical signal to the RF amplifier 418.

The electrical signal produced from detected light may be processed using various circuit types and arrangements. In one example, the RF amplifier 418 includes a current-voltage converting circuit and a matrix computing and amplifying circuit. In a matrix arrangement, a plurality of light-receptor elements in the photodetector 416 are connected to the computing and amplifying matrix to produce multiple signals. Typical generated signals include a radio frequency signal that carries reflected information, a focus error signal FE for performing a servo control operation, and a tracking error signal TE.

The tracking servo 324 controls the feed motor 322 to move the objective lens in the optical pickup unit 122 in a radial direction with respect to the optical storage medium 312. The focusing servo 326 is used to generate a focus error signal that indicates the amount of displacement from the focused-state location based on information carried by laser beams reflected from the optical storage medium 312. The focusing servo 326 generates a focus drive signal that is applied to change focusing of the optical pickup unit 122, for example by regulating a focusing coil in a biaxial focusing mechanism.

Referring again to FIG. 3, signals resulting from the detected light in the optical pickup unit 122 are communicated to multiple processing elements including data processor 330, focusing servo 326, and tracking servo 324. In one example, the reproduction RF signal output from the RF amplifier 418 is processed by a binary decision element in the data processor 330. The focusing servo 326 processes the focus error signal FE and tracking servo 324 handles the tracking error signal TE. The reproduction RF signal obtained from the RF amplifier 418 can be converted into a binary signal by the data processor 330 in the form of an EFM+signal or an 8-16 demodulation signal. The EFM+signal can be supplied to a decoder (not shown) to perform EFM+demodulation, error correction, and other possible functions. In some systems, MPEG decoding may be performed to reproduce data read from optical storage medium 312. Decoded data may be stored as a data buffer in a memory element (not shown), for example internal to the data processor 330, the processor 340, the host computer 350, or in external storage.

The data processor 330 receives information and control signals including focusing error signals and tracking error signals from the optical pickup unit 122, and a spindle error signal from the spindle motor controller 316 or the processor 340. Based on the information and control signals, the data processor 330 generates a plurality of servo drive signals such as a focus drive signal, a tracking drive signal, and a spindle drive signal.

The optical disk drive system 310 typically operates in an initial coarse tracking mode to locate a desired track. During coarse tracking, processor 340 calculates the difference between the current track of the optical storage medium 312 and the target track and determines the direction of movement. The difference calculated is the remaining distance the optical pickup unit 122 is to travel to reach the target track. The difference is loaded into a counter in the servo system comprised of the tracking servo 324 and the focusing servo 326. The tracking servo 324 then drives the optical pickup unit 122 in the desired direction. The optical pickup unit 122 generates the tracking error signal (TE). When the optical pickup unit 122 is traversing the disk, the tracking error signal (TE) is a sinusoidal waveform with a zero crossing wherever the optical pickup unit 122 passes a track center. One cycle of the TE signal represents crossing of one track. Using the TE signal, the tracking servo system 324 determines when the optical pickup unit 122 crosses a track and decrements a counter by one.

The tracking servo 324 continues to drive the optical pickup unit 122 until the counter decrements to zero where the optical pickup unit 122 reads the current track information and begins a fine search operation to arrive at the target track. For the counter to decrement correctly, the tracking servo 324 is to accurately detect track crossings. Erroneous track crossing detection events cause the track counter to miscount, and the optical pickup unit 122 to grossly mis-position, so that the optical disk drive system 310 has to re-seek, significantly increasing the seek time.

Some servo systems track crossing counts utilizing a tracking error crossing signal TX and a quadrature signal RX. The TX signal is the digitized waveform of the tracking error signal TE. The quadrature signal RX is the digitized waveform of the radio frequency ripple signal RFRP. The RFRP signal is derived from summed output signals from photodiodes within optical pickup unit 122 upon detection of reflected laser illumination.

When the optical pickup unit 122 is positioned above or below a track center, the summed signal is a data signal and contains high frequency components. When the optical pickup unit 122 is traversing the optical storage medium 312 during the search operation, the summed signal becomes modulated. The modulation of the summed signal is a sinusoidal waveform 90 degrees out of phase with the tracking error signal TE. The optical pickup unit 122 generates the RFRP signal by filtering high frequency components from of the summed signal and digitizing to, yield the RX signal.

Noise contamination commonly afflicts the TX and RX signals, and can lead to erroneous track crossing detection and miscounts, causing the optical pickup unit 122 to arrive at the wrong track.

During a data read operation, the optical disk drive system 310 attempts to seek to a particular area of what is presumed to be a conventional optical record medium. The focusing servo 326 and tracking servo 324 respond to optical input signals to perform focusing and tracking operations. However, the illustrative system does not include the conventional optical record medium and track crossings so that the tracking operation may lead to open loop operation with no servo feedback. Accordingly, a simulation technique may be utilized during the seek operation to simulate track crossings, for example by creating suitable optical signals to satisfy the seek operation.

In an illustrative embodiment, the digital AV to optical conversion apparatus 100 overrides the tracking operation of a conventional opto-electronic device by directing light from an external source into the optical pickup unit 122 to illuminate tracking diodes equally. Thus, the tracking servo control loop determines that tracking lock is attained since the input error between the photodiode signals is essentially equal to zero due to equality of illumination strength received at each photo diode.

In an alternative embodiment, the digital AV to optical conversion apparatus 100 may override the tracking operation by modulating light from an external source into the optical pickup unit 122 in a manner that simulates track crossings, for example presuming that the tracks are arranged in a linear bar pattern. The digital AV to optical conversion apparatus 100 creates suitable optical signals to satisfy the seek operation. A short duration seek is suitable for simple and efficient operation.

In a further alternative embodiment, the digital AV to optical conversion apparatus 100 utilizes a position or motion sensor that detects movement of the optical pickup unit 122 and modulates the external source to simulate track crossings.

Simple optic experiments can be performed by one having ordinary skill in the art to determine suitable optical signals for simulating the seek and tracking operations.

The focusing servo 326 typically operates as a feedback control system. The objective lens 414 is in focus for only a very narrow range. Therefore, a focus search operation is generally performed to properly operate the focusing servo 326 when the focusing servo 326 begins operation, and occasionally thereafter. In the focus search operation, a focus drive signal is applied to the focusing coil in the optical pickup unit 122 to move the objective lens 414 in a focusing position range.

The optical storage medium 312 has one or more reflective layers for encoding information. For example, a disk having a plurality of signal-record surfaces such as a two-layered DVD, includes multiple reflective layers in the form of a semi-transparent film allowing some proportion of the laser illumination to be reflected and allowing a portion to pass through. The focusing servo 326 operates to selectively focus laser illumination on particular layers allowing information to be read from the multiple layers.

For an optical storage medium 312 having a plurality of signal-record surfaces, the focusing servo 326 can focus laser illumination beams on each of the signal-record surfaces. The focusing servo 326 can execute a focus jump operation to change focus of the light beams from a first to a second signal-record surface. Fundamentally, the focus jump operation is executed by deactivating the focusing servo 326 and forcing the objective lens 414 to move while laser beams are focused on a first signal-record surface of the optical storage medium 312. Then the focusing servo 326 is activated at the moment the objective lens 414 moves into the focus draw-in range with respect to a second signal-record surface.

The processor 340 can execute the focus jump operation by deactivating the focusing servo 326 and controlling the objective lens 414 to move when the laser beams are focused on a signal-record surface. The processor 340 can activate the focusing servo 326 at a moment the objective lens arrives within a focusing range with respect to another signal-record surface. In one example, the focus search operation may be requested when accessing a second address at a different signal-record surface from the signal-record surface currently being recorded or read when the objective lens is focused.

A general technique for the seek operation involves executing a focus jump from a current address location at a first signal-record surface to a second signal-record surface to seek a target location at the second signal-record surface. During the focus jump operation, the objective lens 414 is moved with an acceleration that exceeds the acceleration of the motion of the optical storage medium 312 to reduce the effects of outside disturbances. However, for an optical storage medium 312 with highly accelerated movements, the focus of the objective lens 414 is considerably displaced within a rotational period of the optical storage medium 312. Furthermore, due to the radial arrangement of the optical storage medium 312, surface motion is more pronounced toward the periphery of the optical storage medium 312. Accordingly, a particular focus jump operation may fail due to large optical storage medium 312 motion simply because of the relative positions of the access locations. For a particular focus jump operation, a re-try may be needed to attain successful execution, resulting in delay in access of information at a target location.

The processor 340 controls the focus jump sequence by monitoring the focus error signal FE. In one example, the processor 340 controls a focus jump sequence in the following manner. In a first condition, a seek operation has a target address with a radial distance closer to the inner peripheral side of the optical storage medium 312 than the current address location, the optical storage medium 312 has multiple signal-record surfaces, and the current and target locations are on different signal-record surfaces. First, the processor 340 seeks a radial location on the current location signal-record surface that substantially corresponds with the target address on the target location signal-record surface. Second, the processor 340 executes a focus jump operation to move from the current location signal-record surface to the target location signal-record surface.

In a second condition, a seek operation has a target address with a radial distance farther from the inner peripheral side of the optical storage medium 312 than the current address location, and the current and target locations are on different signal-record surfaces. First, the processor 340 executes a focus jump operation from the current location signal-record surface to the other signal-record surface. Then the processor 340 seeks the target location on the other signal-record surface. The processor 340 controls the focus jump sequence in the same manner when the current address location and the target address location are positioned on different signal-record layers.

Accordingly, since optical storage medium motion is greater near the outer periphery of the disk, focus jumping is carried out to a disk radial location that corresponds to the current or target address location that is positioned closer to the inner periphery of the optical storage medium 312. Thus, the probability that a focus jump error occurs due to the effects of disk-surface shaking is reduced.

In an illustrative embodiment, the digital AV to optical conversion apparatus 100 overrides the focus search operation of a conventional opto-electronic device by directing light from an external source into the optical pickup unit 122 in a manner that illuminates all regions of the photodiode array equally. Thus, the focus servo control loop of the conventional optical device detects the focus lock condition since the relative input error among the photodiodes is essentially equal to zero due to equality of light strength received at each photo diode.

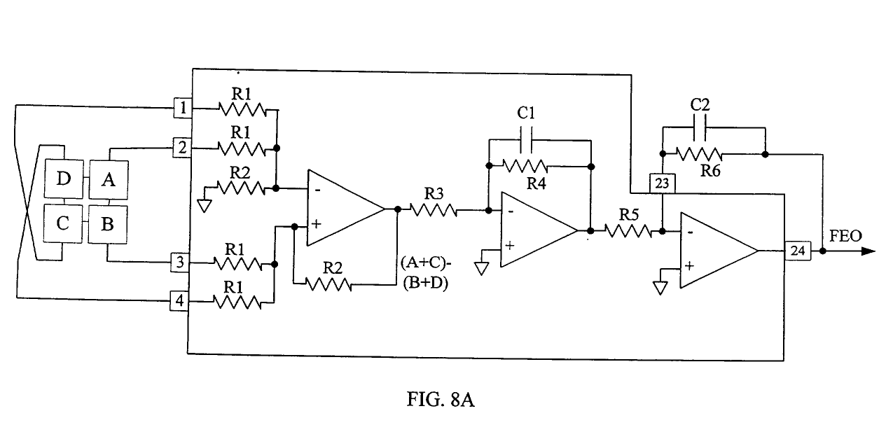

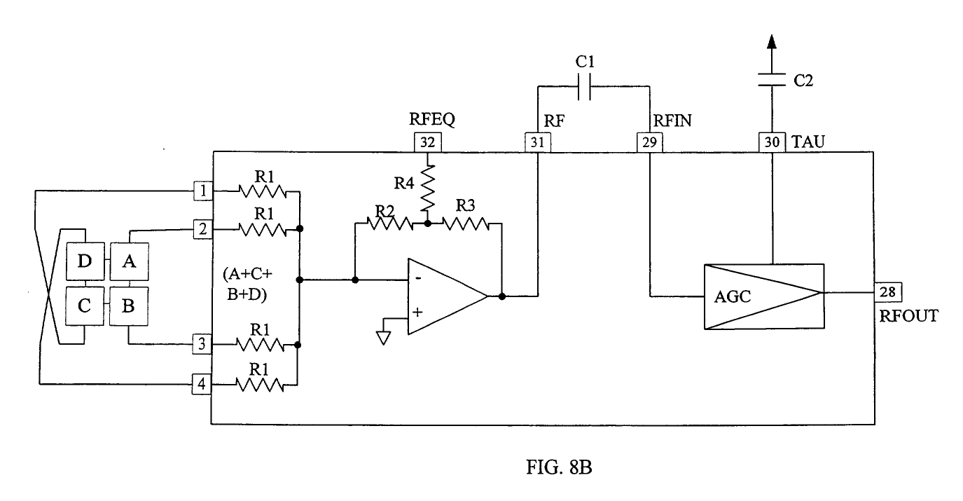

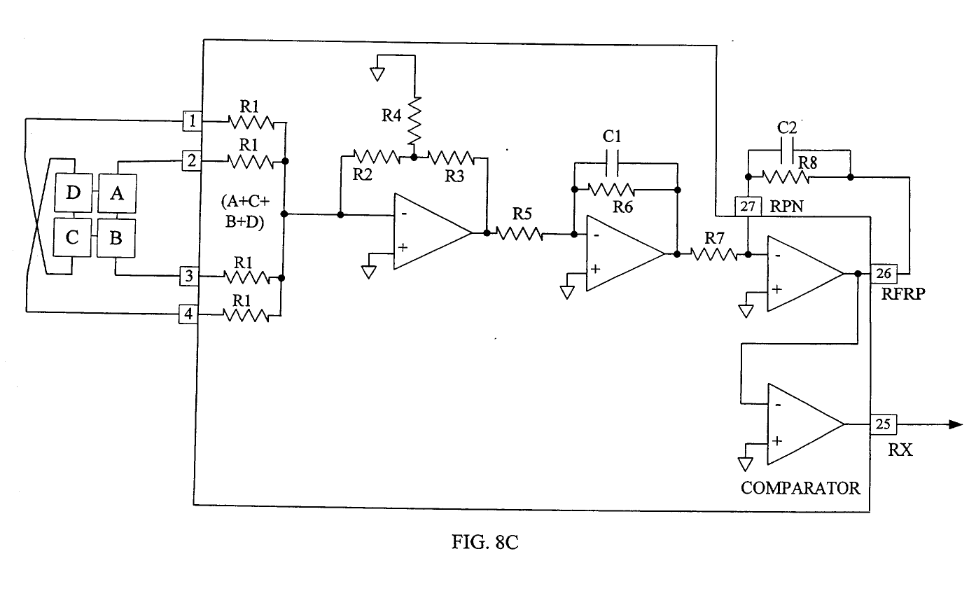

Referring to FIGS. 8A, 8B, and 8C, schematic circuit diagrams depict examples of suitable circuits for analyzing a focus path, a radio frequency (RF) path, and RF crossing, respectively, in one example of an optical pickup unit.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the invention. Variations and modifications of the embodiments disclosed herein may be made based on the description set forth herein, without departing from the scope and spirit of the invention as set forth in the following claims.

In the claims, unless otherwise indicated the article “a” is to refer to “one or more than one”.

What is claimed is:

1. An opto-electronic apparatus comprising:
an opto-electronic transducer including an input terminal capable of receiving an electronic signal, the transducer capable of converting the electronic signal to an optical signal; and
a substrate capable of coupling to the opto-electronic transducer and having a form factor of an optical record medium, the substrate capable of substituting for the optical record medium and delivering the optical signal to an optical pickup of an opto-electronic device.

2. An opto-electronic apparatus according to claim 1 wherein:
the opto-electronic device is a legacy opto-electronic player or player-recorder such as a CD player deck, a CD jukebox, or a DVD player.

3. An opto-electronic apparatus according to claim 1 further comprising:
the opto-electronic transducer comprising;
a laser illumination source;
a laser driver coupled to the laser illumination source and capable of driving the laser illumination source; and
an opto-electronic controller capable of controlling a conventional CD or DVD player, and coupled to the laser driver and the laser illumination source to modulate the laser illumination source.

4. An opto-electronic apparatus according to claim 1 further comprising:
the opto-electronic transducer comprising;
a laser illumination source;
a laser driver coupled to the laser illumination source and capable of driving the laser illumination source; and
an opto-electronic controller coupled to the laser driver and the laser illumination source to modulate the laser illumination source, the modulated laser illumination being capable of usage as an optical network having a terminal node that is the optical pickup of an opto-electronic device, the opto-electronic device being a conventional CD or DVD player.

5. An opto-electronic apparatus according to claim 1 further comprising:
the opto-electronic transducer comprising;
a laser illumination source;
a laser driver coupled to the laser illumination source and capable of driving the laser illumination source; and
an opto-electronic controller coupled to the laser driver and the laser illumination source to modulate the laser illumination source, the modulated laser illumination being capable of usage as an optical network having a terminal node that is the optical pickup of an opto-electronic device, the opto-electronic device being a conventional CD or DVD player,
the opto-electronic controller being capable of driving the laser illumination source to perform one or more control operations that are capable of overriding control operations of the conventional CD or DVD player.

6. An opto-electronic apparatus according to claim 1 further comprising:
the opto-electronic transducer comprising:
a laser illumination source;
a laser driver coupled to the laser illumination source and capable of driving the laser illumination source; and
an opto-electronic controller coupled to the laser driver and the laser illumination source to modulate the laser illumination source, the modulated laser illumination being capable of usage as an optical network having a terminal node that is the optical pickup of an opto-electronic device, the opto-electronic device being a conventional CD or DVD player,
the opto-electronic controller being capable of driving the laser illumination source to perform one or more control operations that are capable of overriding control operations of the conventional CD or DVD player, the control operations of the conventional CD or DVD player being selected from among an error correcting operation, a servo control operation, and a track locking correcting operation.

7. An opto-electronic apparatus according to claim 1 further comprising:
the opto-electronic transducer comprising:
a laser diode;
a CD-RW controller;
a CD-RW front end circuit coupled to the CD-RW controller and to the laser diode, the CD-RW controller and the CD-RW front end circuit being capable of controlling the laser diode to generate optical illumination that modulates a photoreceptor in the optical pickup of the opto-electronic device, the modulated laser illumination being capable of usage as an optical network having a terminal node that is the optical pickup of an opto-electronic device, the opto-electronic device being a conventional CD or DVD player,
the CD-RW controller and the CD-RW front end being capable of driving the laser illumination source to perform one or more control operations that are capable of overriding control operations of the conventional CD or DVD player, the control operations of the conventional CD or DVD player being selected from among an error correcting operation, a servo control operation, and a track locking correcting operation.

8. An opto-electronic apparatus according to claim 1 further comprising:
the opto-electronic transducer comprising:
an encoder capable of encoding an electronic signal into an electronic frequency modulated signal;
a laser diode; and
a laser driver coupled between the encoder and the laser diode capable of generating a radio-frequency signal that can drive the laser diode.

9. An opto-electronic apparatus according to claim 1 further comprising:
the opto-electronic transducer comprising:
an encoder capable of encoding an electronic signal into an electronic frequency modulated signal;
a laser diode;
a laser driver coupled between the encoder and the laser diode capable of generating a radio-frequency signal that can drive the laser diode, a controller capable of controlling the opto-electronic transducer to generate optical illumination that modulates a photoreceptor in the optical pickup of the opto-electronic device; and
a controller capable of controlling the opto-electronic transducer to modulate the laser diode.

10. An opto-electronic apparatus according to claim 1 further comprising:
the opto-electronic transducer comprising:
a laser diode;
a CD-RW controller;
a CD-RW front end circuit coupled to the CD-RW controller and to the laser diode, the CD-RW controller and the CD-RW front end circuit being capable of controlling the laser diode to generate optical illumination that modulates a photoreceptor in the optical pickup of the opto-electronic device.

11. An opto-electronic apparatus according to claim 1 further comprising:
the opto-electronic transducer comprising:
a laser diode;
a DVD controller;
a DVD front end circuit coupled to the DVD controller and to the laser diode, the DVD controller and the DVD front end circuit being capable of controlling the laser diode to generate optical illumination that modulates a photoreceptor in the optical pickup of the opto-electronic device.

12. An opto-electronic apparatus according to claim 1 further comprising:
the opto-electronic transducer comprising:
an encoder capable of encoding a digital electronic signal into an electronic frequency modulated signal;
a laser diode capable of generating a laser illumination signal;
a laser driver coupled between the encoder and the laser diode capable of generating a radio-frequency signal that can drive the laser diode; and
an optical conduit coupled to the laser diode and capable of communicating the laser illumination signal.

13. An opto-electronic apparatus according to claim 1 further comprising:
the opto-electronic transducer comprising:
an analog to digital converter capable of receiving an audio signal and converting the audio signal to a pulse code modulated signal;
an encoder coupled to the analog to digital converter and capable of encoding a digital electronic signal from the analog to digital converter or another source into an electronic frequency modulated signal;
a laser diode; and
a laser driver coupled between the encoder and the laser diode capable of generating a radio-frequency signal that can drive the laser diode.

14. An opto-electronic apparatus according to claim 1 further comprising:
the opto-electronic transducer comprising:
an encoder coupled to the analog to digital converter and capable of encoding a digital electronic signal;
a laser diode coupled to the encoder; and
a laser driver coupled between the encoder and the laser diode capable of generating a radio-frequency signal that can drive the laser diode.

15. An opto-electronic apparatus according to claim 1 further comprising:
the opto-electronic transducer comprising:
an encoder coupled to the analog to digital converter and capable of encoding a compressed MPEG digital electronic signal from a video imaging device;
a laser diode coupled to the encoder; and
a laser driver coupled between the encoder and the laser diode capable of generating a radio-frequency signal that can drive the laser diode.

16. An opto-electronic apparatus according to claim 1 further comprising:
the opto-electronic transducer comprising:
an encoder coupled to the analog to digital converter and capable of encoding a compressed JPEG digital electronic signal from a video imaging device;
a laser diode coupled to the encoder; and
a laser driver coupled between the encoder and the laser diode capable of generating a radio-frequency signal that can drive the laser diode.

17. An opto-electronic apparatus according to claim 1 further comprising:
a laser emitter; and
the substrate including a support for holding the laser emitter, the substrate being capable of inserting the laser emitter into the opto-electronic device so that the opto-electronic device processes illumination from the laser emitter in the manner that the opto-electronic device reads from an optical medium.

18. An opto-electronic apparatus according to claim 1 further comprising:
a laser emitter; and
the substrate including a support for holding the laser emitter, the substrate being capable of inserting the laser emitter into a conventional CD player deck so that the conventional CD player deck processes illumination from the laser emitter in the manner that the conventional CD player deck reads from a conventional CD medium.

19. An opto-electronic apparatus according to claim 1 further comprising:
a laser emitter; and
the substrate being mountable on a rotatable turntable of a conventional opto-electronic device, the substrate being capable of holding the laser emitter and maintaining the laser emitter in a substantially fixed position as the turntable rotates.

20. An opto-electronic apparatus according to claim 1 further comprising:
the substrate in the form of a multiple-segment disc comprising:
an interior section that is capable of rotating; and
a peripheral section that can be either fixed in position or moveable, the peripheral section being capable of coupling to the optical pickup of the opto-electronic device.

21. An opto-electronic apparatus according to claim 1 further comprising:
the substrate in the form of a multiple-segment disc comprising:
an interior section that is capable of rotating;
a peripheral section that can be either fixed in position or moveable; and
a laser emitter capable of coupling to the peripheral section, the laser emitter remaining stationary over the optical pickup of the opto-electronic device.

22. An opto-electronic apparatus comprising:
a laser emitter; and
an opto-electronic transducer including an input terminal capable of receiving electronic signals, the transducer capable of controlling a conventional CD or DVD player to modulate the laser emitter and convert the electronic signals to optical signals that emulate laser signals generated by reading of optical media by a conventional opto-electronic device.

23. An opto-electronic apparatus according to claim 22 further comprising:
a laser driver coupled to the laser emitter and capable of driving the laser emitter source; and
an opto-electronic controller capable of controlling a conventional CD or DVD player, and coupled to the laser driver and the laser illumination source to modulate the laser emitter.

24. A method of operating an opto-electronic apparatus comprising:
receiving an electronic signal;
controlling a conventional CD or DVD player to modulate a laser emitter;
converting the electronic signal to an optical signal that emulates laser signals generated by reading of optical media by a conventional opto-electronic device.

25. An opto-electronic apparatus comprising:
a laser illumination source;
a laser driver coupled to the laser illumination source and capable of driving the laser illumination source; and
an opto-electronic controller coupled to the laser driver and the laser illumination source to modulate the laser illumination source, the modulated laser illumination being capable of usage as an optical network having a terminal node that is the optical pickup of an opto-electronic device.

26. An opto-electronic apparatus according to claim 25 wherein:
the opto-electronic device is a conventional CD or DVD player.

27. An opto-electronic apparatus according to claim 25 wherein:
the opto-electronic controller is capable of driving the laser illumination source to perform one or more control operations that are capable of overriding control operations of the conventional CD or DVD player.

28. A method of operating an opto-electronic apparatus comprising:
modulating a laser illumination source; and
using the modulated laser illumination as an optical network having a terminal node that is the optical pickup of an opto-electronic device.

29. A method according to claim 28 wherein:
the opto-electronic device being a conventional CD or DVD player.

30. A method according to claim 28 further comprising:
performing one or more control operations that are capable of overriding control operations of the conventional CD or DVD player.

31. A method according to claim 28 further comprising:
performing one or more control operations that are capable of overriding control operations of the conventional CD or DVD player, the control operations being selected from among error correcting, servo control, and track locking correction operations.

32. An opto-electronic apparatus comprising:
a laser emitter; and
a substrate including a support for holding the laser emitter, the substrate being capable of inserting the laser emitter into the opto-electronic device so that the opto-electronic device processes illumination from the laser emitter in the manner that the opto-electronic device reads from an optical medium.

33. An opto-electronic apparatus according to claim 32 wherein:
the substrate is capable of inserting the laser emitter into a conventional CD player deck so that the conventional CD player deck processes illumination from the laser emitter in the manner that the conventional CD player deck reads from a conventional CD medium.

34. A method of operating an opto-electronic apparatus comprising:
supporting a laser emitter on a substrate;
inserting the substrate and laser emitter into the opto-electronic device so that the opto-electronic device processes illumination from the laser emitter in the manner that the opto-electronic device reads from an optical medium.

35. A method according to claim 34 further comprising:
inserting the laser emitter into a conventional CD player deck so that the conventional CD player deck processes illumination from the laser emitter in the manner that the conventional CD player deck reads from a conventional CD medium.

36. An opto-electronic apparatus comprising:
a laser emitter; and
a substrate mountable on a rotatable turntable of a conventional opto-electronic device, the substrate being capable of holding the laser emitter and maintaining the laser emitter in a substantially fixed position as the turntable rotates.

37. An opto-electronic apparatus according to claim 36 further comprising:
the substrate in the form of a multiple-segment disc comprising:
an interior section that is capable of rotating; and
a peripheral section that can be either fixed in position or moveable, the peripheral section being capable of coupling to the optical pickup of the opto-electronic device.

38. An opto-electronic apparatus according to claim 36 further comprising:
the substrate in the form of a multiple-segment disc comprising:
an interior section that is capable of rotating;
a peripheral section that can be either fixed in position or moveable; and
a laser emitter capable of coupling to the peripheral section, the laser emitter remaining stationary over the optical pickup of the opto-electronic device.

39. A method of operating an opto-electronic apparatus comprising:
mounting a substrate on arotatable turntable of a conventional opto-electronic device; and
holding a laser emitter in a substantially fixed position while rotating the turntable.

40. A method according to claim 39 further comprising:
providing the substrate in the form of a multiple-segment disc comprising:
an interior section that is capable of rotating; and
a peripheral section that can be either fixed in position or moveable, the peripheral section being capable of coupling to the optical pickup of the opto-electronic device.

41. A method according to claim 39 further comprising:
providing the substrate in the form of a multiple-segment disc comprising:
an interior section that is capable of rotating;
a peripheral section that can be either fixed in position or moveable; and
a laser emitter capable of coupling to the peripheral section, the laser emitter remaining stationary over the optical pickup of the opto-electronic device.

42. An opto-electronic apparatus comprising:
a laser illumination source;
a laser driver coupled to the laser illumination source and capable of driving the laser illumination source; and
an opto-electronic controller coupled to the laser driver and the laser illumination source to modulate the laser illumination source, the modulated laser illumination being capable of usage as an optical network having a terminal node that is the optical pickup of an opto-electronic device,
the opto-electronic controller being capable of driving the laser illumination source to perform one or more control operations that are capable of overriding control operations opto-electronic device, the control operations of the opto-electronic device being selected from among an error correcting operation, a servo control operation, and a track locking correcting operation.

43. An opto-electronic apparatus according to claim 42 wherein:
the opto-electronic device is a conventional CD or DVD player.

44. An opto-electronic apparatus according to claim 42 further comprising:
a laser diode;
a CD-RW controller; and
a CD-RW front end circuit coupled to the CD-RW controller and to the laser diode, the CD-RW controller and the CD-RW front end circuit being capable of controlling the laser diode to generate optical illumination that modulates a photoreceptor in the optical pickup of the opto-electronic device, the modulated laser illumination being capable of usage as an optical network having a terminal node that is the optical pickup of an opto-electronic device, the opto-electronic device being a conventional CD or DVD player,
the CD-RW controller and the CD-RW front end being capable of driving the laser illumination source to perform one or more control operations that are capable of overriding control operations of the conventional CD or DVD player, the control operations of the conventional CD or DVD player being selected from among an error correcting operation, a servo control operation, and a track locking correcting operation.

45. A method of operating an opto-electronic apparatus comprising:
modulating a laser illumination source;
using the modulated laser as an optical network having a terminal node that is the optical pickup of an opto-electronic device; and
driving the laser illumination source to perform one or more control operations that are capable of overriding control operations of the opto-electronic device.

46. A method according to claim 45 wherein:
the opto-electronic device being a conventional CD or DVD player.

47. A method according to claim 45 further comprising:
executing the control operations of the opto-electronic device selected from among an error correcting operation, a servo control operation, and a track locking correcting operation.

48. A method according to claim 45 further comprising:
controlling a laser diode to generate optical illumination that modulates a photoreceptor in the optical pickup of the opto-electronic device;
using the modulated laser illumination as an optical network having a terminal node that is the optical pickup of an opto-electronic device, the opto-electronic device being a conventional CD or DVD player; and
driving the laser diode using a CD-RW controller and a CD-RW front end to perform one or more control operations that are capable of overriding control operations of the conventional CD or DVD player.

49. A method according to claim 45 further comprising:
executing the control operations of the conventional CD or DVD player selected from among an error correcting operation, a servo control operation, and a track locking correcting operation.

50. A method according to claim 45 further comprising:
overriding a tracking operation of a conventional opto-electronic device by directing light from an external source to illuminate a plurality of tracking diodes equally.

51. A method according to claim 45 further comprising:
overriding a tracking operation of a conventional opto-electronic device by modulating light from an external source to simulate track crossings.

52. A method according to claim 45 further comprising:
overriding a tracking operation of a conventional opto-electronic device by detecting movement of an optical pickup unit of the conventional opto-electronic device and modulating light from an external source to simulate track crossings.
